(19) United States
(12) Patent Application Publication
(10) Pub. No.: US 2018/0165510 A1
(43) Pub. Date: Jun. 14, 2018

(54) METHOD AND APPARATUS FOR 3D FACIAL RECOGNITION

(71) Applicant: Indiana University Research and Technology Corporation, Indianapolis, IN (US)

(72) Inventors: Matthew William Anderson, Bloomington, IN (US); Thomas Sterling, Bloomington, IN (US); Bo Zhang, Bloomington, IN (US)

(73) Assignee: Indiana University Research and Technology Corporation, Indianapolis, IN (US)

(21) Appl. No.: 15/576,560

(22) PCT Filed: May 27, 2016
(86) PCT No.: PCT/US16/34610

§ 371 Date: Nov. 22, 2017

Related U.S. Application Data
(60) Provisional application No. 62/168,363, filed on May 29, 2015.

(51) Int. Cl. G06K 9/00; G06T 17/00

(52) U.S. Cl. CPC G06K 9/00248; G06T 2207/10028; G06T 17/005; G06K 9/00201

(57) ABSTRACT

The present disclosure relates to methods and apparatuses for 3-D facial recognition using the Fast Multipole Method (FMM).

### CROSS-REFERENCE TO RELATED APPLICATIONS

This application claims priority to U.S. Provisional Application Ser. No. 62/168,363, entitled METHOD AND APPARATUS FOR 3D FACIAL RECOGNITION that was filed on May 29, 2015, the entire disclosure of which is hereby expressly incorporated herein by reference.

### FIELD

The present disclosure relates to three-dimensional (3D or 3-D) facial recognition, and more particularly to a method and apparatus for 3D facial recognition using the Fast Multiple Method (FMM).

### BACKGROUND

Face recognition has long been a key component in visual and experiential computing. Real-time face recognition, for instance, can translate a complex and large visual dataset into a very small and accessible piece of valuable information for human decision making. While 2-D face recognition systems are prevalent today, robust positive identification in the presence of environmental changes such as lighting and expression variations can be difficult to achieve.

Work in 3-D face recognition implementations has been dominated by explicit surface representations including point clouds, contour and profile curves, polygon meshes, and height maps. Polygon meshes represent the majority use case for current 3-D face recognition technologies. Explicit representations present some challenges when fitting a surface to 3-D point data. For example, fitting a surface to 3-D point data using an explicit representation requires searching to find the facet closest to a 3-D data point using a distance function which is not smooth. Implicit surface representations such as radial basis functions have not been used in the context of 3-D face recognition applications.

### SUMMARY

3-D face recognition provides increased robustness against environmental variations over 2-D face recognition approaches. However, 3-D face recognition requires constructing a surface representation that is efficient, fast to construct, and useful for statistical modeling. In the exemplary embodiments of the present disclosure, the high computational complexity of surface representations with desirable properties for face recognition such as low input data requirements and an ability to enforce smoothness constraints motivates the use of multipole methods, including the Fast Multipole Method (FMM) and/or the Fast Gaussian Transform (FGT), as a key component for 3-D face recognition.

The present disclosure provides a method of achieving 3-D face recognition through an advanced multipole method. Rapid real time 3-D face recognition from multiple input data streams is provided based on radial basis functions through the Fast Multipole Method (FMM) (or Fast Gaussian Transform (FGT)) computed within the context of a global address space and dynamic adaptive runtime software. In some embodiments, radial basis functions for facial surface representation provide efficiency and ease of use in statistical modeling. In some embodiments, FMM and its associated Fast Gaussian Transform (FGT) provide fast alternatives to scattered data interpolation over other methods and without complex preconditioning requirements. The present disclosure provides 3-D facial recognition using implicit surface representation through radial basis functions by means of FMM. In one embodiment, scattered point cloud data is interpolated with radial basis functions implemented by FMM.

In some embodiments, the Fast Multipole Method (FMM) computed within the context of a global address space and dynamic adaptive runtime software is used for rapid real-time 3-D face recognition from multiple data streams. In some embodiments, the Fast Multipole Method (FMM) enables fast scattered-data interpolation and accelerates 3-D face recognition technologies based on implicit surface representations while improving the accuracy of such technologies.

In some embodiments, the 3-D face recognition system and method of the present disclosure has application to biometrics, security, person tracking, image segmentation use, and other suitable applications. In some embodiments, the 3-D face recognition system and method of the present disclosure has application to any real-time process with visual and experiential computing needs.

In some embodiments, the system and method of the present disclosure provides one or more of the following: implements FMM for radial basis function interpolation from scattered point cloud data; implements FMM 3-D facial surface reconstruction using publicly available databases; implements real-time capability for FMM 3-D face recognition; and provides a domain specific language (DSL) for FMM 3-D face recognition.

In some embodiments, the present disclosure provides a fine-grained data-driven approach for multipole methods to address the limitations of conventional face recognition practices and improve scalability and efficiency. A software library employs dynamic adaptive execution methods with multipole-specific strategies for fault tolerance and exception handling while simplifying the implementation of the fast multipole method and the Barnes-Hut algorithm for end-users.

Additional features and advantages of the present disclosure will become apparent to those skilled in the art upon consideration of the following detailed description of the illustrative embodiments exemplifying the best mode of carrying out the invention.

### BRIEF DESCRIPTION OF THE DRAWINGS

The detailed description of the drawings particularly refers to the accompanying figures in which:

FIG. 1 illustrates an exemplary basic dataflow of a two dimensional FMM algorithm according to some embodiments using four levels of subdivision;

FIG. 2 illustrates a merge and shift technique for the FMM algorithm of FIG. 1;

FIG. 3 illustrates exemplary components and semantics of the ParalleX execution model according to some embodiments;

FIG. 4 illustrates a block diagram of an exemplary facial recognition system including at least one computing device in communication with an image acquisition device and one or more databases;

FIG. 5A illustrates an exemplary flow of operation of the facial recognition system of FIG. 4

FIGS. 5B-5E are various perspective views of an exemplary scattered point cloud from FIG. 5A; and

FIG. 6 illustrates a flow diagram of an exemplary facial recognition operation executed by the computing device of FIG. 4 using the Fast Multipole Method (FMM).

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of a cognitive assessment device, it should be understood that the concepts presented herein may be used in other various configurations consistent with this disclosure.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

The present disclosure provides a method of achieving 3-D face recognition through an advanced multipole method. Rapid real time 3-D face recognition from multiple input data streams is provided based on radial basis functions through the Fast Multipole Method (FMM) computed within the context of a global address space and dynamic adaptive runtime software. In some embodiments, radial basis functions for facial surface representation provide efficiency and ease of use in statistical modeling. In some embodiments, FMM and/or its associated Fast Gaussian Transform (FGT) provide fast alternatives to scattered data interpolation over other methods and without complex preconditioning requirements. The facial recognition system of the present disclosure provides 3-D facial recognition using implicit surface representation through radial basis functions by means of FMM. In one embodiment, scattered point cloud data is interpolated with radial basis functions implemented by FMM.

In some embodiments, the 3D facial recognition of the present disclosure uses a global address space model such as those available in Unified Parallel C, Coarray Fortran, Fortress, Chapel, X10, Global Arrays, and/or HPX-5 to enable the random data access type computations for face recognition statistical analysis. The global address pace model serves to scale in distributed memory systems and enable scalable big data computations. As face databases exceed the memory capacity of a single computing node, the global address space model provides a scalable framework on which to base 3-D face recognition. In one illustrated embodiment, FMM based 3-D face recognition uses the HPX-5 runtime system software and the active global address space provided by the HPX-5 runtime system. The HPX-5 runtime system also provides multi-core, embedded computing core, and real-time computing support. In the context of FMM, HPX-5 in some embodiments provides semantics to improve the likelihood of addressing the low data-reuse ratio intrinsic to multipole methods and hiding memory access latency. With a global address model in place, the system and method of the present disclosure provide a fast framework for FMM based 3-D face recognition that uses radial basis functions and is capable of big data computations.

Multipole methods may be applied to N-body or N-body like problems. In such problems, a kernel function describes how two particles interact with each other. Multipole methods may be based on an assumption that the net result of a large number of individual interactions with distant objects can be treated as a single interaction under appropriate conditions. The Fast Multipole Method (FMM) is an example of a multipole method with arithmetic complexity of order N (“O(N)”). In the context of radial basis function interpolation, FMM enables the fast approximation of matrix-vector products to arbitrary accuracy. For radial basis function interpolation with N data samples and M evaluation points, conventional techniques would require O(N×M) operations while FMM finishes in O(N+M) operations.

In one illustrated embodiment, FMM achieves this speedup by hierarchically subdividing the computational domain, thereby creating a tree structure. The root of this tree represents the entire computational volume, with each child representing a fraction of the volume of its parent. The volume is subdivided until a predetermined stopping criterion is reached. In FMM, the leaves of the tree often contain multiple particles.

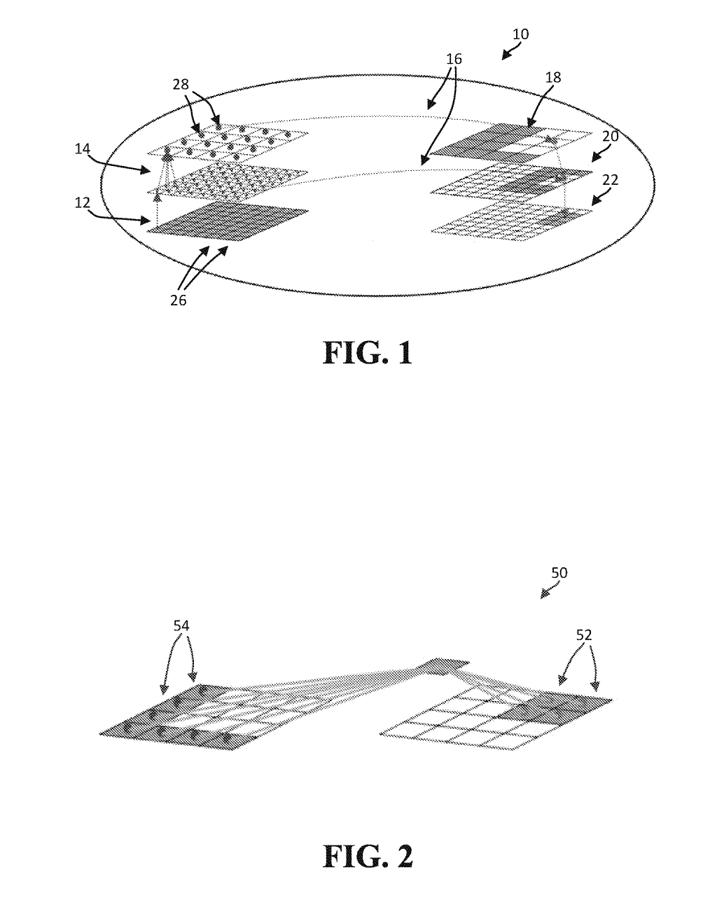

FIG. 1 illustrates an exemplary basic dataflow 10 of a two dimensional FMM algorithm according to some embodiments using four levels of subdivision. The shaded boxes (nodes) 26 on the left-hand side each represent a cluster of source locations, while dots 28 on the left-hand side each represent the multipole expansion.

After the subdivision of the domain, the algorithm contains an upward pass of the tree that generates the multipole expansion for each node of the tree. This uses two fundamental operations, the source-to-multipole (S2M) operator 12, which generates the multipole expansion for a single leaf of the tree, and the multipole-to-multipole (M2M) operator 14, which uses the multipole expansions of the children of a given node to compute the multipole expansion for that node. In this way, information about the particle distribution propagates upward toward the root of the tree, with each node having a multipole expansion for the particles inside its volume.

In one illustrated embodiment, after the multipole expansions are computed, the FMM performs at least two extra operations on the nodes. First, the multipole expansion of the nodes in the so-called interaction list region—those nodes far away enough that their expansions can be used, but not so far away that their parent's expansions can be used (see the gray shaded region 18 on the right-hand side of FIG. 1)—are translated into local expansions using the multipole-to-local (M2L) operator 16. For example, this translation allows the effect of a distant node to be applied only once to a given node at the same level of refinement. Second, the node inherits the local expansion from its parent node using the local-to-local (L2L) operator 20. In some embodiments, this allows the local expansion of higher level nodes to be applied to nodes at a finer level of refinement. At the finest subdivision level, the FMM resumes operation at the particle level; the local expansion of the node containing the target point is evaluated using the local-to-target (L2T) operator 22 and interactions with neighboring particles are computed via the direct pairwise interactions.

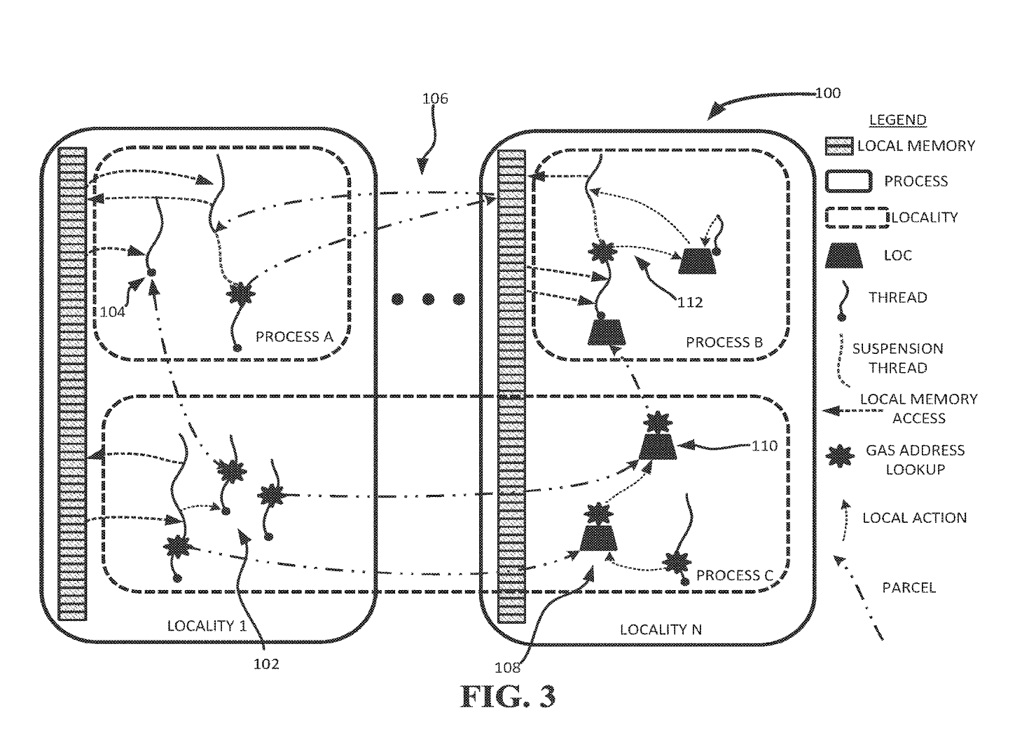

In some embodiments, there exists significant overlap of the interaction list regions for nodes of the same parent in the FMM. Repeated work may be reduced by using a merge-and-shift technique, as illustrated in the representation 50 of FIG. 2. In this technique, if there are M common nodes in the interaction list regions for a given set of N nodes, the merge-and-shift technique merges the M multipole expansion into one, which is then shifted to N nodes, using M+N translations, instead of doing M×N translations. By applying this technique, the average number of M2L translations performed for each node can be reduced in three dimensions. For example, referring to FIG. 2, each shaded node 52 on the right-hand side needs to convert the multipole expansions of the seven shaded nodes 54 on the left-hand side in the M2L phase. Instead of doing 7×4 translations, the seven multipole expansions may be merged into one expansion, which is shifted to the four nodes on the right, using 7+4 translations.

An exemplary feature of FMM in one illustrated embodiment is the construction of a directed acyclic graph (DAG) representing the flow of data in the method. The DAG encodes both the flow of source particle data to multipole moments and also the resulting multipole moment to the target locations. In some embodiments, multipole methods may then be seen as the construction of a dataflow DAG followed by a traversal of that DAG. In some embodiments of FMM, the DAG is a bipartite graph with each component including a tree—one tree represents the source particles and the other tree represents the application of the local expansion translation operations, L2L and L2T. Connecting the two trees in FMM are edges of the DAG representing the M2L operations.

In one illustrated embodiment, the FMM operations are linearly proportional to the input data size and implement the merge-and-shift technique that reduces the time complexity prefactor. Using a runtime system, the FMM of the present disclosure also incorporates techniques to address the low data-reuse ratio intrinsic to multipole methods and hide memory access latency.

The FMM of the present disclosure enables the use of radial basis functions for 3-D face recognition. In some embodiments, as part of a class of implicit surface representations radial basis functions provide several advantages over their explicit surface representation counterparts which are beneficial for feature-based and appearance-based face recognition approaches, for example.

Implicit surface representations may be isosurfaces (or iso-levels) of a scalar function, as opposed to explicit surface representations such as meshes or point clouds where all dependent variables may be written explicitly in terms of the independent variables. Implicit surfaces are well suited for fitting smooth objects such as human faces. For example, the distance function is smooth and differentiable for implicit surface representations, thereby reducing the likelihood of the problems associated with fitting exclusively with explicit representations.

In one illustrated embodiment, radial basis functions may use a variety of basis functions, including linear, Gaussian, spline (e.g., cubic spline), or other suitable basis functions, to create a weighted sum and model a surface. An exemplary feature of radial basis function interpolation for face recognition is the ability to find the signed distance function, yielding the distance from an arbitrary point to the closest point on the surface. In some embodiments, the signed distance function also enables level set approaches for face recognition. The level set method is capable of handling partial occlusions, such as the presence of eyeglasses, a hand, or other objects, in the face data.

Spherically sampled radial basis function (SSR) shape descriptors, which are based on the signed distance function derived from radial basis functions, provide a type of local surface representation. Using SSR shape descriptors to examine the convexity of local surface shapes and with the use of histograms, pose-invariant convexity values for facial features may be determined. Accordingly, in some embodiments, SSR shape descriptors may be used to help resolve face alignment issues and figures as well as implement feature-based face recognition in the FMM 3-D face recognition of the present disclosure.

Conventional radial basis function interpolation with N centers requires order N² (“O(N²)”) operations while FMM of the present disclosure enables radial basis function interpolation in O(N) operations. In some embodiments, this speedup reduces the likelihood of a need for large distributed simulations for radial basis function interpolation. However, the random data access patterns for face recognition with huge databases of face data suggests the use of a global address space model. In one illustrated embodiment, the global address space implementation is provided with the HPX-5 runtime system, although other suitable runtime systems may be used in various embodiments.

The irregular data structures needed for large 3-D face recognition may be difficult to implement in conventional distributed memory models. In some embodiments, global address space models provide the asynchronous random access suitable for large-scale practical vision recognition. While many suitable global address space model implementations are available, one exemplary implementation utilizes the HPX-5 runtime system. In some embodiments, the HPX-5 system provides embedded, real-time, and dynamic tasking support.

The HPX-5 runtime system is a dynamic tasking runtime system, supporting lightweight ephemeral threads in the context of an active global address space. In one embodiment, the HPX-5 runtime system implements the ParalleX execution model, which describes a hierarchy of processing tasks, the structured objects upon which they operate, and the organization and synchronization of concurrency as well as the means of managing the uncertainty of operational asynchrony. The ParalleX execution model serves as framework for the ongoing monitoring of system behavior and the policies for adjusting priorities of task and data placement in response to the system and application state. The ParalleX execution model also reflects local relationships, both physical and abstract. The (i) distribution of parallel work and resources and the (ii) relative affinity of spatial and temporal locality guide dynamic load balancing to maximize concurrency of execution, while minimizing overheads and latencies.

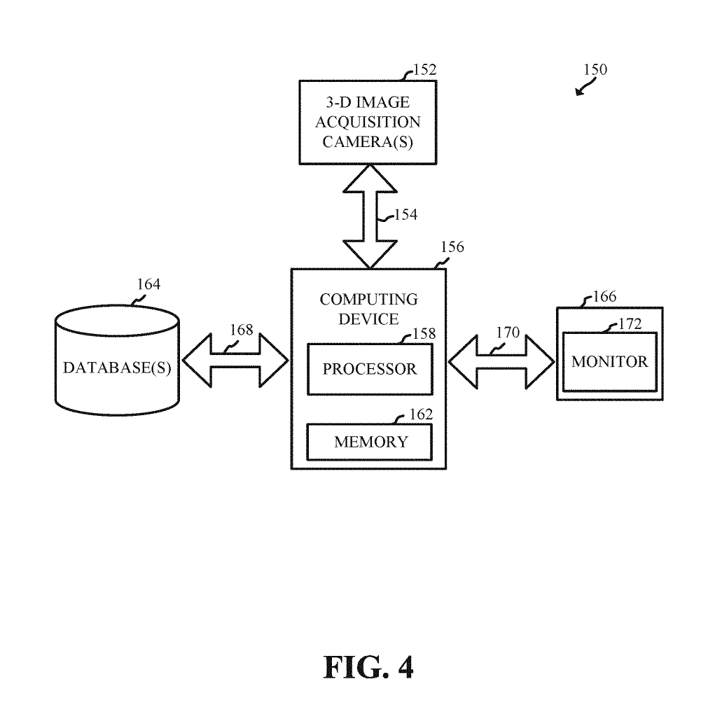

Exemplary components and semantics of the ParalleX execution model are illustrated in the representation 100 of FIG. 3. FIG. 3 illustrates the interaction of primary semantic components of the dynamic execution model. Local Control Objects (LCO) provide event coordination and management for the lightweight threads in the context of the Global Address Space (GAS). Six types of events are illustrated (local thread instantiation 102, remote thread instantiation 104, remote atomic memory operation 106, depleted thread activation 108, dataflow object trigger 110, and future value access 112), including examples of two specific types of LCOs, futures and dataflow. The execution strategy illustrates a work queue many-tasking execution model.

In terms of practical, real-time 3-D face recognition, the global address space model enables computational statistics on face databases larger than memory available on a single computing node. The real-time capability of HPX-5 guarantees bounded response time of a workload triggered by an initial condition or event. The embedded computing core support in HPX-5 enables greater diversity in execution environment and potentially mobile implementations. While multithreaded support is not required for FMM based radial basis function interpolation, FMM implemented in the runtime system is operative to take advantage of multicore systems if available for faster 3-D face recognition performance.

In some embodiments, HPX-5 or other suitable runtime system semantics enable a fine-grained data driven approach to FMM implementation. In one embodiment, a feature of multipole methods is that all the input data is not necessarily ready before processing them. The fine-grained data driven approach allows some overlap of operations and a capability to hide memory latency. Second, the runtime system in some examples integrates both the memory model and the thread scheduler to help address the low data-reuse ratio intrinsic to multipole methods and further hide memory access latency.

HPX-5 is a C-language based software library developed by CREST at Indiana University. HPX-5 software may be developed using common tools such as the GNU Compiler Collection (GCC), autotools, make, and libtool. Exemplary functions of the HPX-5 runtime system include: global address space management and address translation; thread queuing and scheduling; parcel communications protocol and message packet transfer; synchronization objects, structures, and state transition; capabilities protection; and introspection, measurement, and dynamic policies.

The HPX-5 application program interface (API) forms the initial syntax for implementing the FMM radial basis function interpolation and the SSR histogram approach. This exposes and exploits runtime system information while enabling investigation into enforcing bounded response times of workloads on conventional and embedded computing cores. A syntax is designed for FMM based 3-D face recognition for improving usability that is used as a basis for a domain specific language (DSL) for 3-D face recognition. The DSL is operative to hide the implementation details of both FMM and the underlying runtime system while producing efficient architecture-specific code from high-level abstractions.

In one embodiment, the code may be operative to implement a diversity of feature segmentation, for example focusing on those features which show the least sensitivity to facial expressions in 3-D, including the region around the eyes, the nose, and the forehead. In some embodiments, kernel density estimators may provide an alternative to histogram based methods. The results of 3-D face recognition based on FMM may be based on feature-based methods and/or on appearance-based statistical methods.

In some embodiments, the FMM 3-D face recognition code of the present disclosure is optimized for real-time capability for testing in a mobile environment. In one embodiment, kernel independent approaches for radial basis may function as well as a cascaded filtering process serves to improve accuracy in feature-based face recognition.

In some embodiments, the 3-D face recognition system of the present disclosure reduces the computational complexity associated with an entire class of implicit surface representations, including radial basis functions. This fine-grained, data-driven FMM implementation may incorporate semantics to hide memory latency and program using high level abstractions available as part of a DSL.

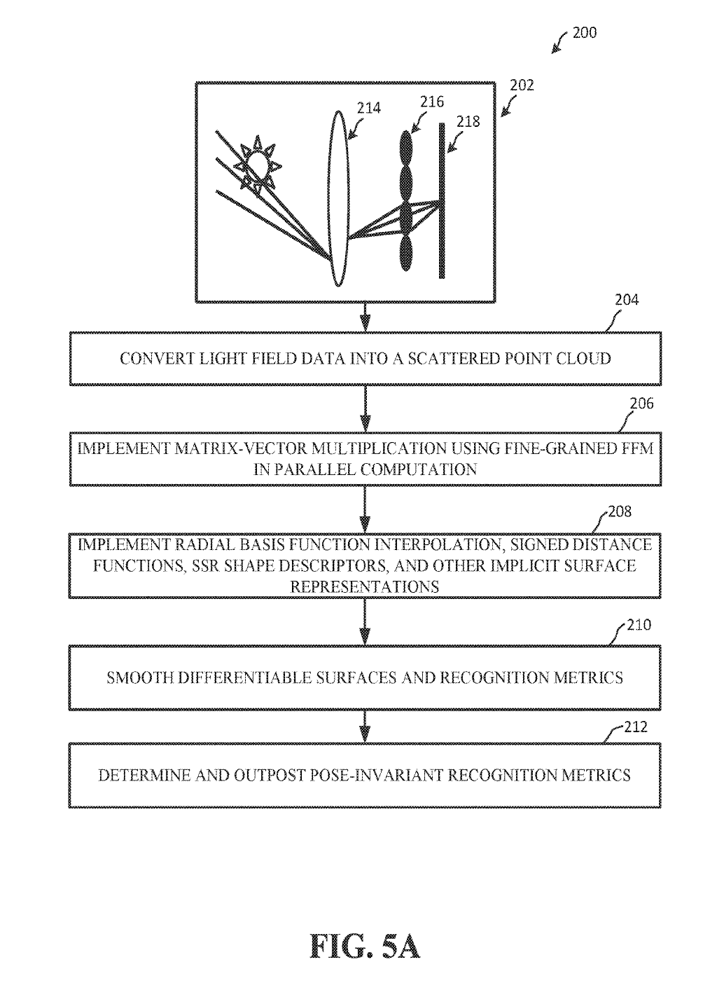

Referring to FIG. 4, an exemplary facial recognition system 150 is illustrated according to some embodiments. Facial recognition system 150 is operative to perform rapid real time 3-D facial recognition from multiple input data streams based on radial basis functions through the Fast Multipole Method (FMM) computed within the context of a global address space and dynamic adaptive runtime software.

Facial recognition system 150 includes one or more computing devices 156 in communication with one or more databases 164. Database(s) 164 include one or more data stores for storing the face data provided with computing device 156 and/or plenoptic cameras 152. Computing device 158 includes at least one processor 158 and memory 162 accessible by processor 158. Memory 162, which comprises one or more memory locations, includes software containing instructions executable by processor 158. In one illustrated embodiment, memory 162 contains the adaptive runtime software (e.g., HPX-5, etc.) executed by processor 158 to perform the facial recognition functionality described herein. Memory 162 may be internal or external to computing device 156. Processor 158 includes any suitable processing device or devices operative to execute the software/firmware stored at memory 162. For example, processor 158 may include one or more programmable processors (e.g., central processing unit (CPU) devices), application-specific integrated circuits (ASICs), field-programmable gate arrays (FPGAs), digital signal processors (DSPs), hardwired logic, or combinations thereof. Computing device 156 is operative to manage the retrieval of data from and routing of data to database 164. In one embodiment, computing device 156 includes multicore embedded computing cores.

In one illustrated embodiment, computing device 156 acquires 3-D images from one or more image capture devices, such as cameras, such as plenoptic cameras 152 or other suitable cameras or image acquisition devices via any suitable communication link 154. The acquired images may be stored in databases 164. Computing device 156 also acquires previously stored 3-D images from database 164, such as for comparison with the images acquired from plenoptic cameras 152. Databases 164 may include one or more publicly available databases such as Texas 3D Face Recognition Database (Texas 3DFRD), the Bosphorus Database, and the Binghampton 3D Facial Expression Database.

System 150 includes a user interface 166 comprising one or more user input devices such as a keyboard, mouse pointer, touchscreen, or other suitable input device. User interface 166 further includes a monitor 172, such as a graphical user interface or other display, for displaying data and facial recognition analyses results to a user and displaying selectable inputs to a user. User interface 166 and database 164 are coupled to computing device 156 via any suitable communication links 170, 168, such as a data bus, computer networking protocol link (e.g., internet protocol (IP)), Ethernet network, local or wide area network, wireless or wired link, etc.

In one embodiment, computing device 156 implements the spherically-sampled radial basis function (SSR) histogram approach for nose tip localization in the FMM facial surface reconstruction code. Nose tip identification and localization provides for the repeatable 3-D face alignment for 3-D face recognition. This feature identification mechanism serves to identify other features of the face such as beards, glasses, or self-occlusion. In some embodiments, the FMM facial recognition features implemented by computing device 156 are tested against noisy face data as well as data from local 3-D face acquisition systems, such as from plenoptic cameras 152. In some embodiments, plenoptic cameras 152 are installed on autonomous vehicles, such as drones or airborne vehicles for capturing 3-D images of human faces or other features. An exemplary plenoptic camera 152 uses a microlens-equipped sensor to capture the full ray-structure of a scene. Using this ray-structure, the three-dimensional structure of the scene is reconstructed using direct or Radon-transform methods, for example. An exemplary microlens sensor array consists of 100 by 80 microlenses with each 280 μm separation, although other suitable array configurations may be provided.

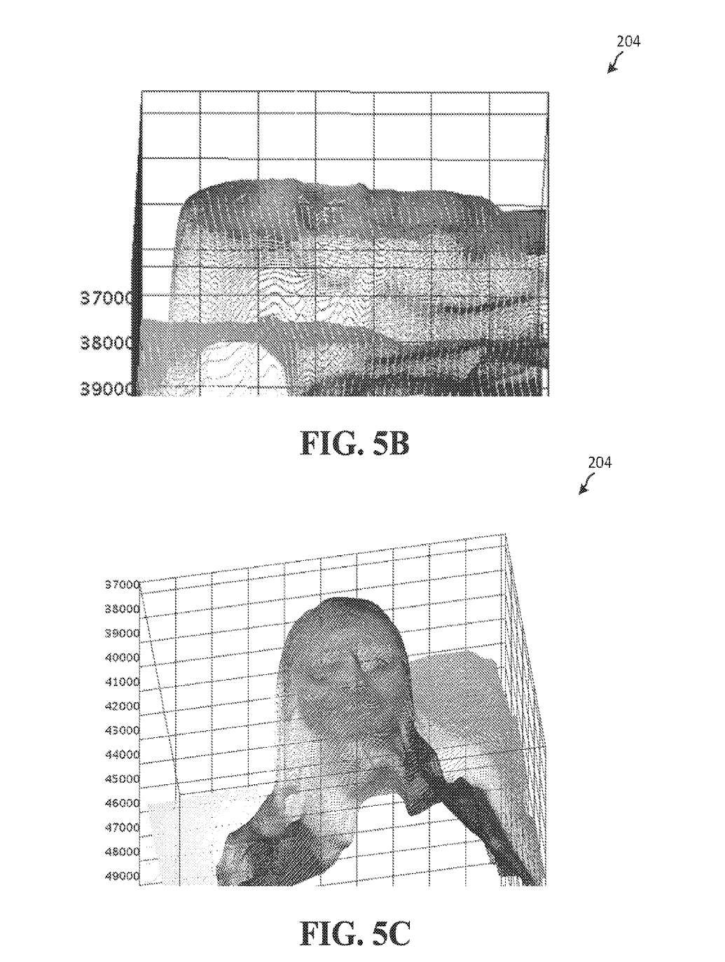

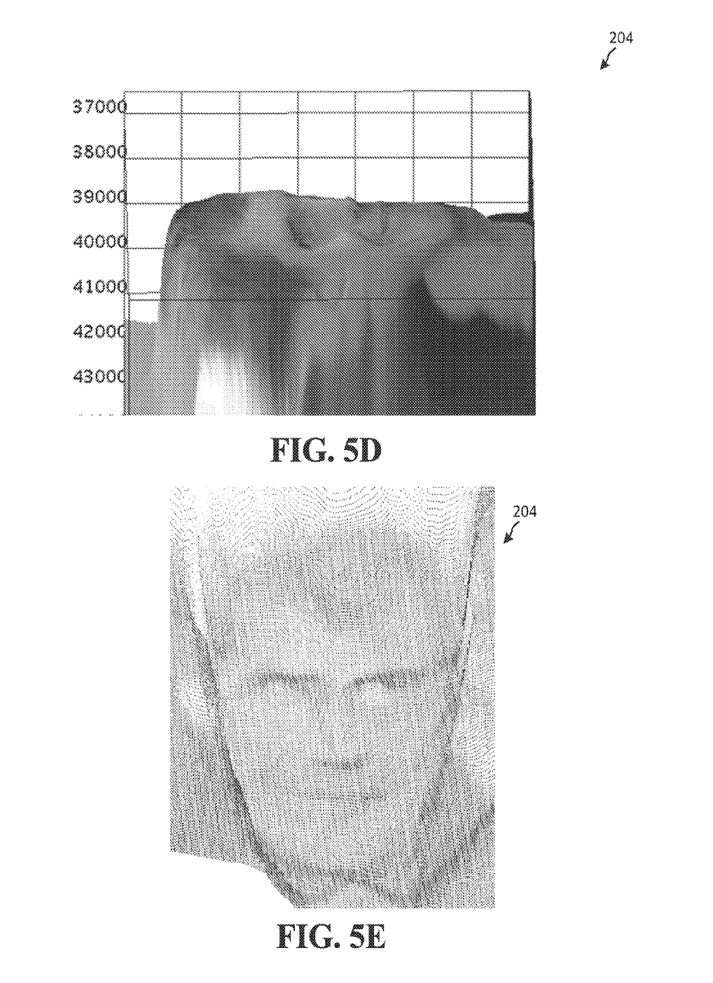

Referring to FIG. 5A, an exemplary flow 200 of an operation of facial recognition system 150 of FIG. 4 is illustrated. At block 202, an image acquisition device captures a 3-D image and provides it to computing device 156 of FIG. 4. Illustratively, the image acquisition device includes a camera lens 214, a microlens array 216, and a charge coupled device (CCD) image sensor 218. At 204, the light field data is converted into a scattered point cloud (various perspectives of which are shown in FIGS. 5B-5E) by computing device 156. At block 206, computing device 156 implements matrix-vector multiplication using fine-grained FMM in parallel computation for large 3-D datasets while hiding memory access latency. At blocks 208, computing device 156 implements radial basis function interpolation, signed distance functions, SSR shape descriptors, and other implicit surface representations as described herein. At block 210, the differentiable surfaces are smoothed by computing device 156. At block 212, computing device 156 determines and outputs pose-invariant recognition metrics.

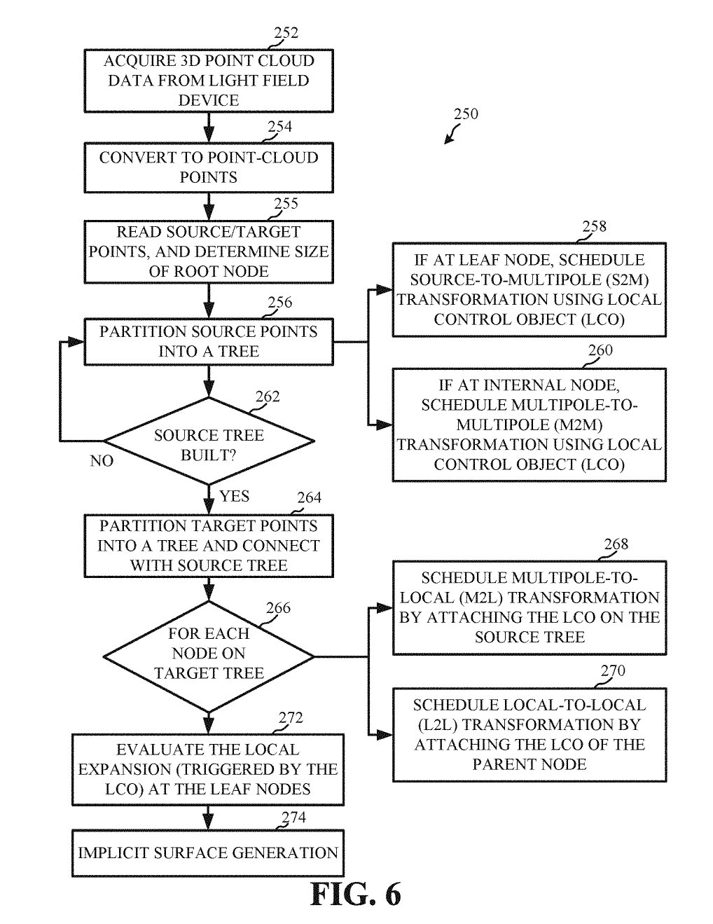

Referring to FIG. 6, a flow diagram 250 of an exemplary method of operation of computing device 156 of FIG. 4 is illustrated according to one embodiment. As illustrated in flow diagram 250, by coordinating the M2L and M2M transformations using Local Control Objects, an overlap of computational phases is accomplished thereby hiding memory access latency and optimizing the execution flow for the implicit surface generation needed for 3-D face recognition.

Local Control Objects (LCO) serve to provide the global layer of control state and are lightweight synchronization constructs that may be linked together in dynamic graphs for access and manipulation. While there are many forms including conventional semaphores and mutexes, at least the dataflow and futures constructs serve to manage asynchrony, establish constraint-based flow control, support anonymous producer-consumer computation, exploit graph meta-data parallelism, balance eager versus lazy evaluation based on resource availability, and perform many other functionalities.

To begin, the FMM implemented by computing device 156 hierarchically subdivides the computational domain, naturally creating a bipartite graph with two tree components. For example, at block 252 computing device 156 acquires 3D point cloud data from the light field device, such as plenoptic camera 152 of FIG. 4. At block 254, computing device 156 converts the acquired data to point-cloud points. At block 255, computing device 156 reads the source/target points and determines the size of the root node.

At block 256, computing device 156 partitions the source points into a tree. In one embodiment, the root of this tree represents the entire computational volume, with each child representing a fraction of the volume of its parent. The volume is subdivided until some stopping criterion is reached. In FMM, the subdivision halts with the leaves of the tree often containing multiple particles. After the subdivision of the domain, computing device 156 using FMM implements an upward pass of the tree that generates the multipole expansion for each node of the tree. This uses two fundamental operations, the source-to-multipole (S2M) operator, which generates the multipole expansion for a single leaf of the tree, and the multipole-to-multipole (M2M) operator, which uses the multipole expansions of the children of a given node to compute the multipole expansion for that node itself. In this way, information about the particle distribution propagates upward toward the root of the tree, with each node having a multipole expansion for the particles inside its volume.

For example, if at a leaf node (block 258) the computing device 156 schedules source-to-multipole (S2M) transformation using a local control object (LCO), and if at an internal node (block 260) the computing device 156 schedules multipole-to-multipole (M2M) transformation using a local control object (LCO). Once the source tree is built (block 262), computing device 156 partitions the target points into a tree and connects it with the source tree at block 264.

After the multipole expansions are computed, the FMM implemented by computing device 156 performs two operations on each node in the target tree 266 at blocks 268 and 270. First, the multipole expansion of the nodes in the so called interaction list region—those nodes far away enough that their expansions can be used, but not so far away that their parent's expansions can be used—are translated into local expansions using the multipole-to-local (M2L) operator at block 268. This translation allows the effect of a distant node to be applied only once to a given node at the same level of refinement. Second, the node inherits the local expansion from its parent node using the local-to-local (L2L) operator at block 270. This allows the local expansion of higher level nodes to be applied to nodes at a finer level of refinement. At the finest subdivision level, the FMM implemented by computing device 156 resumes operation at the particle level. At block 272, the local expansion of the node containing the target point is evaluated using the local-to-target (L2T) operator and interactions with neighboring particles are computed via the direct pairwise interactions. At block 274, computing device 156 generates surfaces using implicit surface generation.

While the present disclosure relates to techniques for facial recognition, other human features and/or areas of the human body may be analyzed and recognized by computing system 150 of FIG. 4 using the techniques described herein.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of three-dimensional facial recognition comprising:
receiving, by at least one computing device, at least one input data stream comprising three-dimensional point cloud data;
implementing, by the at least one computing device, a three-dimensional facial recognition routine based on radial basis functions through a Fast Multipole Method (FMM) computed within the context of a global address space; and
determining, by the at least one computing device, recognition metrics based on the facial recognition routine.

2. The method of claim 1, wherein the three-dimensional facial recognition routine includes
converting the acquired three-dimensional point cloud data to point-cloud points;
reading source points and target points and determining a size of a root node;
partitioning the source points into a source tree and the target points into a target tree using multipole expansion;
linking the source tree to the target tree;
performing a local expansion on each node of the target tree; and
performing implicit surface generation.

3. The method of claim 1, wherein the FMM comprises a merge and shift technique.

4. The method of claim 1, further comprising interpolating the three-dimensional point cloud data.

5. The method of claim 1, wherein the at least one input data stream comprises a plurality of data streams.

6. The method of claim 5, wherein the implementing the three-dimensional facial recognition routine is done in real-time.

7. The method of claim 1, further comprising generating, for at least one leaf node, a multipole expansion for a single leaf of the tree.

8. The method of claim 1, further comprising implementing repeatable three-dimensional face alignment.

9. The method of claim 8, wherein the repeatable three-dimensional face alignment comprises nose tip identification, localization, or both.

10. A three-dimensional facial recognition apparatus comprising
a processor and
a non-transitory memory having instructions that, in response to an execution by the processor, cause the processor to
implement a three-dimensional facial recognition routine based on radial basis functions through a Fast Multipole Method (FMM) computed within the context of a global address space; and
determine recognition metrics based on the facial recognition routine.

11. The three-dimensional facial recognition apparatus of claim 10, wherein the non-transitory memory causes the processor to:
convert the acquired three-dimensional point cloud data to point-cloud points;
read source points and target points and determine a size of a root node;
partition the source points into a source tree and the target points into a target tree using multipole expansion;
link the source tree to the target tree;
perform a local expansion on each node of the target tree; and
perform implicit surface generation.

12. The three-dimensional facial recognition apparatus of claim 10, wherein the three-dimensional facial recognition apparatus comprises an image acquisition device.

13. The three-dimensional facial recognition apparatus of claim 12, wherein the image acquisition device is a plenoptic camera.

14. The three-dimensional facial recognition apparatus of claim 10, further comprising a database in electrical communication with the processor.

15. The three-dimensional facial recognition apparatus of claim 14, wherein the database is publically available.

16. The three-dimensional facial recognition apparatus of claim 10, wherein the processor implements FFM three-dimensional facial recognition in real-time.

17. The three-dimensional facial recognition apparatus of claim 10, wherein the processor generates, for at least one leaf node, a multipole expansion for a single leaf of the tree.

18. The three-dimensional facial recognition apparatus of claim 10, wherein the processor implements the FFM comprises a merge and shift technique.

19. A non-transitory computer readable storage medium bearing instructions for three-dimensional facial recognition, the instructions, when executed by a processor in electrical communication a database, cause the processor to perform operations comprising:
implement, by the processor, a three-dimensional facial recognition routine based on radial basis functions through a Fast Multipole Method (FMM) computed within the context of a global address space; and
determine a recognition metric based on the facial recognition routine.

20. The non-transitory computer readable storage medium of claim 19, wherein the non-transitory computer readable storage medium causes the processor to:
convert acquired three-dimensional point cloud data to point-cloud points;
read source points and target points and determining a size of a root node;
partition the source points into a source tree and the target points into a target tree using multipole expansion;
link the source tree to the target tree;
perform a local expansion on each node of the target tree; and
perform implicit surface generation.
